(19) United States
(12) Patent Application Publication
(10) Pub. No.: US 2025/0345819 A1
(43) Pub. Date: Nov. 13, 2025

(54) WATER OUTLET CONTROL STRUCTURE OF WATER SPRAY GUN

(71) Applicant: CIXI TIAN SHUO INDUSTRY TRADE CO.,LTD, CIXI (CN)

(72) Inventor: Kai SHEN, CIXI (CN)

(73) Assignee: CIXI TIAN SHUO INDUSTRY TRADE CO.,LTD, CIXI (CN)

(21) Appl. No.: 18/657,410

(22) Filed: May 7, 2024

(51) Int. Cl. B05B 12/00; B05B 9/01

(52) U.S. Cl. CPC B05B 12/0022; B05B 9/01

(57) ABSTRACT

The disclosure provides a water outlet control structure of a water spray gun, which falls within the technical field of horticultural irrigation tools. The water outlet control structure of the water spray gun includes a water spray gun head and a pressing handle, wherein the water spray gun head is configured to spray water flow; the pressing handle is configured to control a switch of the water flow; the water spray gun head is rotatably connected to the pressing handle; the pressing handle is movably connected to a clamping piece; the water spray gun head is provided with a moving groove at a side wall; the moving groove includes a first sliding groove, a second sliding groove, a third sliding groove, a fourth sliding groove, a first limiting block and a second limiting block; the clamping piece is slidably connected to the moving groove.

### TECHNICAL FIELD

The disclosure belongs to the technical field of horticultural irrigation tools and, in particular, relates to a water outlet control structure of a water spray gun.

### BACKGROUND

The horticultural water spray gun is a tool specifically designed for horticultural irrigation and plant care. Its design allows users to easily control the direction and amount of water flow to meet the irrigation needs of different plants. In ancient times, people watered manually using simple irrigation tools, such as wooden barrels, water tanks, or pouring kettles. This method is inefficient and cannot meet the needs of large-scale horticulture. With the advancement of technology, people have started to use handheld water sprayers for irrigation. These tools, usually made of metal or plastic, allow more precise control of the water flow and increase the efficiency of irrigation.

Hand-held sprayers, when irrigating, typically require the operator to continuously press on the spray head handle to ensure that the water is constantly sprayed. Continuously pressing the handle requires continuous force from the hand muscles, which can lead to fatigue and soreness over time, affecting the user's comfort and work efficiency. Continuously pressing the handle may cause excessive pressure on the finger joints, increasing the risk of joint pain and discomfort, especially for personnel who work continuously for a long time. It may also cause soft tissue injury of hand, such as tendonitis and tenosynovitis, and may require long-term rehabilitation in severe cases.

In view of the above, the existing water spray guns have the problem of requiring long-term pressing during use, which can easily cause hand fatigue.

### SUMMARY

In view of the above, the disclosure provides a water outlet control structure of a water spray gun capable of solving the problem that a conventional water spray gun needs to be pressed for a long time to easily cause hand fatigue during use.

The disclosure is realized in that:

The disclosure provides a water outlet control structure of a water spray gun comprising a water spray gun head and a pressing handle, the water spray gun head being configured to spray water flow, the pressing handle being configured to control a switch of the water flow, and the water spray gun head being rotatably connected to the pressing handle; the pressing handle is movably connected to a clamping piece; the water spray gun head is provided with a moving groove at a side wall; the moving groove comprises a first sliding groove, a second sliding groove, a third sliding groove, a fourth sliding groove, a first limiting block, and a second limiting block; and the clamping piece is slidably connected to the moving groove.

The technical effects of a water outlet control structure of a water spray gun provided by the disclosure are as follows: by providing the water spray gun head, water can be sprayed to a specific position as required; by providing the pressing handle, the flow of the water flow can be controlled, so that the user can conveniently control the start and stop of the water flow to achieve a flexible operation; at the same time, the water source can be saved and the convenience and safety of the operation can be improved; by providing a clamping piece, the water spray of the water spray gun head can be automatically operated, thereby reducing the need for manual intervention and operation; automatic water spray can reduce the fatigue of operator's hands and avoid the discomfort of long-term holding.

On the basis of the above technical scheme, the water outlet control structure of a water spray gun of the disclosure can also be improved as follows:

Wherein the clamping piece comprises a clamping piece body, a sliding portion and a clamping portion; the sliding portion is fixedly connected to a head portion of the clamping piece body; the sliding portion is slidably connected to the moving groove; the clamping portion is fixedly connected to a tail portion of the clamping piece body; and the clamping piece body is movably connected to the pressing handle via the clamping portion.

The advantageous effects of using the above improvement are: by providing the clamping portion, the pressing handle can be driven to be linked with the clamping piece body and the sliding portion, so as to achieve a flexible smooth outflow effect.

Further, the first sliding groove is in communication with the second sliding groove; the first sliding groove is in communication with the third sliding groove; the third sliding groove is in communication with the fourth sliding groove; the fourth sliding groove is in communication with the second sliding groove; the first limiting block is configured to guide the extension direction of the first sliding groove and the second sliding groove; the second limiting block is configured to guide the extension direction of the third sliding groove; the fourth sliding groove and the first limiting block; and the first limiting block and the second limiting block are both fixedly connected to the water spray gun head.

Further, the first sliding groove has a left low and right high configuration; the second sliding groove has a left high and right low configuration; and the fourth sliding groove has a left low and right high configuration.

Further, the height of the second sliding groove is higher than that of the first sliding groove at the communication between the first sliding groove and the second sliding groove; the height of the first sliding groove is higher than that of the third sliding groove at the communication between the first sliding groove and the third sliding groove; the height of the third sliding groove is higher than that of the fourth sliding groove at the communication between the third sliding groove and the fourth sliding groove; the height of the fourth sliding groove is higher than that of the second sliding groove at the communication between the fourth sliding groove and the second sliding groove.

Further, the first limiting block has an arc-shaped bottom triangle structure, and the arc-shaped edge of the first limiting block coincides with one edge of the fourth sliding groove.

Further, the first sliding groove and the second sliding groove both have a letter y-shaped structure.

Compared with the prior art, the technical effects of a water outlet control structure of a water spray gun provided by the disclosure are as follows: by providing the water spray gun head, water can be sprayed to a specific position as required; by providing the pressing handle, the flow of the water flow can be controlled, so that the user can conveniently control the start and stop of the water flow to achieve a flexible operation; at the same time, the water source can be saved and the convenience and safety of the operation can be improved; by providing a clamping piece, the water spray of the water spray gun head can be automatically operated, thereby reducing the need for manual intervention and operation; automatic water spray can reduce the fatigue of operator's hands and avoid the discomfort of long-term holding.

### BRIEF DESCRIPTION OF DRAWINGS

In order to more clearly illustrate the technical solutions of the embodiments of the disclosure, a brief description will be given below of the accompanying drawings which are required to be used in the description of the embodiments of the disclosure. It is obvious that the drawings in the description below are only some embodiments of the disclosure, and it would be obvious for a person skilled in the art to obtain other drawings according to these drawings without involving any inventive effort.

FIG. 1 shows a structure schematic diagram of a water outlet control structure of a water spray gun;

FIG. 2 shows a structure schematic diagram of a clamping piece of a water outlet control structure of a water spray gun;

FIG. 3 shows a front view of a moving groove of a water outlet control structure of a water spray gun; and

FIG. 4 shows a structure schematic diagram of a moving groove of a water outlet control structure of a water spray gun;

In the drawings, the components identified by the reference numerals are listed as follows:
10, water spray gun head; 11, pressing handle; 12, clamping piece; 121, clamping piece body; 122, sliding portion; 123, clamping portion; 13, first sliding groove; 14, second sliding groove; 15, third sliding groove; 16, fourth sliding groove; 17, first limiting block; and 18, second limiting block.

### DETAILED DESCRIPTION OF THE EMBODIMENTS

In order to clarify the purpose, technical solution, and advantages of the embodiments of the disclosure, the following will provide a clear and complete description of the technical solutions in the embodiments of the disclosure in conjunction with the accompanying drawings.

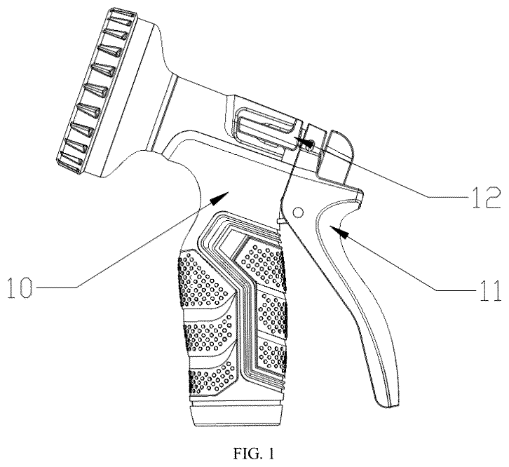

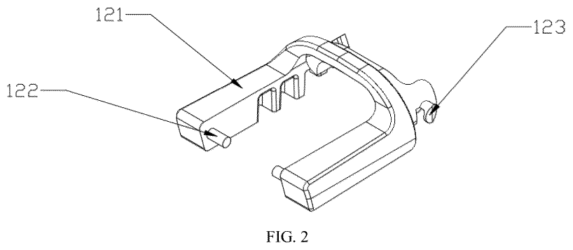

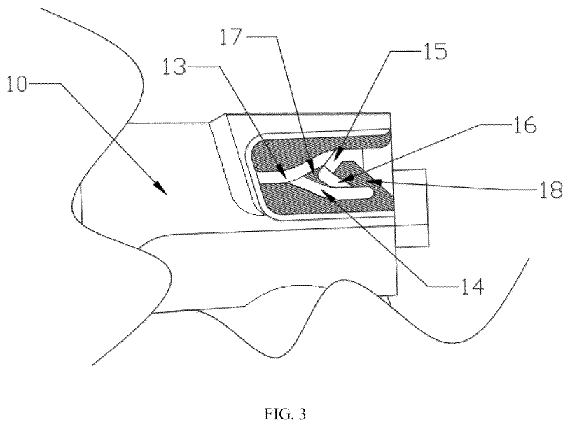

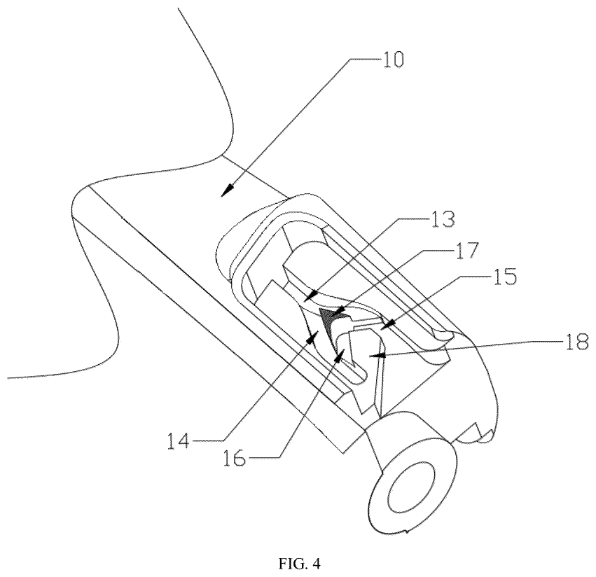

As shown in FIGS. 1-4, it is an embodiment of the water outlet control structure of a water spray gun provided by the disclosure. In this embodiment, it includes a water spray gun head 10 and a pressing handle 11, the water spray gun head 10 being configured to spray water flow, the pressing handle 11 being configured to control a switch of the water flow, and the water spray gun head 10 being rotatably connected to the pressing handle 11; the pressing handle 11 is movably connected to a clamping piece 12; the water spray gun head 10 is provided with a moving groove at a side wall; the moving groove comprises a first sliding groove 13, a second sliding groove 14, a third sliding groove 15, a fourth sliding groove 16, a first limiting block 17, and a second limiting block 18; and the clamping piece 12 is slidably connected to the moving groove.

Before use, the sliding portion 122 is at the leftmost end of the first sliding groove 13 and the water spray gun head 10 is at rest.

In use, pressing the pressing handle 11 causes the pressing handle 11 to shift in the direction of the water spray gun head 10. Since the pressing handle 11 is movably connected to the clamping portion 123, the clamping piece body 121 and the sliding portion 122 are driven to slide to the right in the moving groove. When the pressing handle 11 is continuously pressed, the sliding portion 122 slides from left to right along the first sliding groove 13, and when the sliding portion 122 slides to the junction of the first sliding groove 13 and the second sliding groove 14, since the height of the second sliding groove 14 is higher than that of the first sliding groove 13, the sliding portion 122 continues to slide along the first sliding groove 13. When the clamping piece 12 is in contact with the water spray gun head 10, it cannot be pressed any more, and at this time, the sliding portion 122 just slides from the first sliding groove 13 into the third sliding groove 15. When the pressing handle 11 is released, the pressing handle 11 moves in a direction away from the water spray gun head 10 to drive the clamping piece 12 to slide to the left. Since the height of the first sliding groove 13 is higher than that of the third sliding groove 15, the sliding portion 122 slides along the third sliding groove 15 until sliding into the fourth sliding groove 16. During the above process, as the sliding portion 122 moves, the water spray gun head 10 continues to spray water. When the sliding portion 122 gets stuck between the fourth sliding groove 16 and the first limiting block 17, the water spray gun head 10 will also continue to spray water.

When it needs to be closed, the pressing handle 11 is pressed again, and the sliding portion 122 is driven to slide to the right. Since the height of the third sliding groove 15 is higher than that of the fourth sliding groove 16, the sliding portion 122 moves in the direction of the fourth sliding groove 16 until sliding into the rightmost end of the second sliding groove 14. When the pressing handle 11 is released, the sliding portion 122 is driven to slide from the right to the left along the second sliding groove 14 until sliding into the first sliding groove 13 to reset.

In the above-mentioned technical solution, the clamping piece 12 comprises a clamping piece body 121, a sliding portion 122 and a clamping portion 123; the sliding portion 122 is fixedly connected to a head portion of the clamping piece body 121; the sliding portion 122 is slidably connected to the moving groove; the clamping portion 123 is fixedly connected to a tail portion of the clamping piece body 121; and the clamping piece body 121 is movably connected to the pressing handle 11 via the clamping portion 123.

Further, in the above-mentioned technical solution, the first sliding groove 13 is in communication with the second sliding groove 14; the first sliding groove 13 is in communication with the third sliding groove 15; the third sliding groove 15 is in communication with the fourth sliding groove 16; the fourth sliding groove 16 is in communication with the second sliding groove 14; the first limiting block 17 is configured to guide the extension direction of the first sliding groove 13 and the second sliding groove 14; the second limiting block 18 is configured to guide the extension direction of the third sliding groove 15; the fourth sliding groove 16 and the first limiting block 17; and the first limiting block 17 and the second limiting block 18 are both fixedly connected to the water spray gun head 10.

Further, in the above-mentioned technical solution, the first sliding groove 13 has a left low and right high configuration; the second sliding groove 14 has a left high and right low configuration; and the fourth sliding groove 16 has a left low and right high configuration.

Further, in the above-mentioned technical solution, the height of the second sliding groove 14 is higher than that of the first sliding groove 13 at the communication between the first sliding groove 13 and the second sliding groove 14; the height of the first sliding groove 13 is higher than that of the third sliding groove 15 at the communication between the first sliding groove 13 and the third sliding groove 15; the height of the third sliding groove 15 is higher than that of the fourth sliding groove 16 at the communication between the third sliding groove 15 and the fourth sliding groove 16; the height of the fourth sliding groove 16 is higher than that of the second sliding groove 14 at the communication between the fourth sliding groove 16 and the second sliding groove 14.

Further, in the above-mentioned technical solution, the first limiting block 17 has an arc-shaped bottom triangle structure, and the arc-shaped edge of the first limiting block 17 coincides with one edge of the fourth sliding groove 16.

Further, in the above-mentioned technical solution, the first sliding groove 13 and the second sliding groove 14 both have a letter y-shaped structure.

Specifically, the principles of the disclosure are: before use, the sliding portion 122 is at the leftmost end of the first sliding groove 13 and the water spray gun head 10 is at rest.

In use, pressing the pressing handle 11 causes the pressing handle 11 to shift in the direction of the water spray gun head 10. Since the pressing handle 11 is movably connected to the clamping portion 123, the clamping piece body 121 and the sliding portion 122 are driven to slide to the right in the moving groove. When the pressing handle 11 is continuously pressed, the sliding portion 122 slides from left to right along the first sliding groove 13, and when the sliding portion 122 slides to the junction of the first sliding groove 13 and the second sliding groove 14, since the height of the second sliding groove 14 is higher than that of the first sliding groove 13, the sliding portion 122 continues to slide along the first sliding groove 13. When the clamping piece 12 is in contact with the water spray gun head 10, it cannot be pressed anymore, and at this time, the sliding portion 122 just slides from the first sliding groove 13 into the third sliding groove 15. When the pressing handle 11 is released, the pressing handle 11 moves in a direction away from the water spray gun head 10 to drive the clamping piece 12 to slide to the left. Since the height of the first sliding groove 13 is higher than that of the third sliding groove 15, the sliding portion 122 slides along the third sliding groove 15 until sliding into the fourth sliding groove 16. During the above process, as the sliding portion 122 moves, the water spray gun head 10 continues to spray water. When the sliding portion 122 gets stuck between the fourth sliding groove 16 and the first limiting block 17, the water spray gun head 10 will also continue to spray water.

When it needs to be closed, the pressing handle 11 is pressed again, and the sliding portion 122 is driven to slide to the right. Since the height of the third sliding groove 15 is higher than that of the fourth sliding groove 16, the sliding portion 122 moves in the direction of the fourth sliding groove 16 until sliding into the rightmost end of the second sliding groove 14. When the pressing handle 11 is released, the sliding portion 122 is driven to slide from the right to the left along the second sliding groove 14 until sliding into the first sliding groove 13 to reset.

What is claimed is:

1. A water outlet control structure of a water spray gun, comprising a water spray gun head (10) and a pressing handle (11), the water spray gun head (10) being configured to spray water flow, the pressing handle (11) being configured to control a switch of the water flow, and the water spray gun head (10) being rotatably connected to the pressing handle (11); wherein the pressing handle (11) is movably connected to a clamping piece (12); the water spray gun head (10) is provided with a moving groove at a side wall; the moving groove comprises a first sliding groove (13), a second sliding groove (14), a third sliding groove (15), a fourth sliding groove (16), a first limiting block (17), and a second limiting block (18); and the clamping piece (12) is slidably connected to the moving groove.

2. The water outlet control structure of the water spray gun of claim 1, wherein the clamping piece (12) comprises a clamping piece body (121), a sliding portion (122) and a clamping portion (123); the sliding portion (122) is fixedly connected to a head portion of the clamping piece body (121); the sliding portion (122) is slidably connected to the moving groove;
the clamping portion (123) is fixedly connected to a tail portion of the clamping piece body (121); and the clamping piece body (121) is movably connected to the pressing handle (11) via the clamping portion (123).

3. The water outlet control structure of the water spray gun of claim 2, wherein the first sliding groove (13) is in communication with the second sliding groove (14); the first sliding groove (13) is in communication with the third sliding groove (15); the third sliding groove (15) is in communication with the fourth sliding groove (16); the fourth sliding groove (16) is in communication with the second sliding groove (14); the first limiting block (17) is configured to guide extension directions of the first sliding groove (13) and the second sliding groove (14); the second limiting block (18) is configured to guide extension directions of the third sliding groove (15), the fourth sliding groove (16) and the first limiting block (17); and the first limiting block (17) and the second limiting block (18) are both fixedly connected to the water spray gun head (10).

4. The water outlet control structure of the water spray gun of claim 3, wherein the first sliding groove (13) has a left low and right high configuration; the second sliding groove (14) has a left high and right low configuration; and the fourth sliding groove (16) has a left low and right high configuration.

5. The water outlet control structure of the water spray gun of claim 4, wherein a height of the second sliding groove (14) is higher than that of the first sliding groove (13) at the communication between the first sliding groove (13) and the second sliding groove (14); a height of the first sliding groove (13) is higher than that of the third sliding groove (15) at the communication between the first sliding groove (13) and the third sliding groove (15); a height of the third sliding groove (15) is higher than that of the fourth sliding groove (16) at the communication between the third sliding groove (15) and the fourth sliding groove (16); and a height of the fourth sliding groove (16) is higher than that of the second sliding groove (14) at the communication between the fourth sliding groove (16) and the second sliding groove (14).

6. The water outlet control structure of the water spray gun of claim 5, wherein the first limiting block (17) has an arc-shaped bottom triangle structure, and an arc-shaped edge of the first limiting block (17) coincides with one edge of the fourth sliding groove (16).

7. The water outlet control structure of the water spray gun of claim 6, wherein the first sliding groove (13) and the second sliding groove (14) both have a letter y-shaped structure.
